(19) United States
(12) Patent Application Publication
(10) Pub. No.: US 2017/0057302 A1
(43) Pub. Date: Mar. 2, 2017

(54) RUN FLAT TIRE

(71) Applicant: BRIDGESTONE CORPORATION, Tokyo (JP)

(72) Inventor: Masahiro MAKINO, Tokyo (JP)

(73) Assignee: BRIDGESTONE CORPORATION, Tokyo (JP)

(21) Appl. No.: 15/302,868

(22) PCT Filed: Jan. 30, 2015
(86) PCT No.: PCT/JP2015/000422

§ 371 Date: Oct. 7, 2016

(30) Foreign Application Priority Data
Apr. 14, 2014 (JP) 2014-082820

(51) Int. Cl. B60C 17/00

(52) U.S. Cl. CPC B60C 17/0009; B60C 2017/0054

(57) ABSTRACT

This run flat tire includes a carcass toroidally extending between two bead portions and side reinforcing rubber, having a crescent cross-sectional shape in the tire width direction, on the tire width direction inside of the carcass. The relational expressions 0.09≦TWH/TW≦0.19, D/SH≦0.05, and 0.89≦TW/SW≦0.94 are satisfied, where, in a reference state such that the run flat tire is mounted on an applicable rim and inflated to a prescribed internal pressure with no load, TW (mm) represents the half width in the tire width direction between the tread edges, TWH (mm) represents the radial drop height of the tread edge, SW (mm) represents half of the tire maximum width, SH (mm) represents the tire cross-sectional height, and D (mm) represents the drop height of the tire at a position 0.6SW (mm) outward, in the tire width direction, from the tire equatorial plane.

### TECHNICAL FIELD

This disclosure relates to a run flat tire that, in the side portion thereof, has side reinforcing rubber with a crescent cross-sectional shape in the tire width direction.

### BACKGROUND

In a run flat tire that, in the side portion thereof, has side reinforcing rubber with a crescent cross-sectional shape in the tire width direction, i.e. in a side-reinforced type run flat tire, it is known that the vertical spring constant of the tire increases as a result of providing the side reinforcing rubber in the tire side portion, thereby reducing the ride comfort.

JP 2007-069775 A (PTL 1) discloses that the rubber volume of the side reinforcing rubber can be reduced by using an extremely round outline shape for the tread, thereby keeping the increase in tire mass and the reduction in ride comfort low while guaranteeing the run flat capability.

### CITATION LIST

### Patent Literature

PTL 1: JP 2007-069775 A

### SUMMARY

### Technical Problem

However, in the tire disclosed in PTL 1, the tread has an extremely round outline shape, which reduces the volume of the side reinforcing rubber that can be disposed in the tire side portion. As a result, distortion of the side reinforcing rubber layer increases during run flat running, which may worsen the run flat durability.

Furthermore, another main technical problem with run flat tires has been making ride comfort compatible with run flat durability. At the same time, in the major European market, fuel efficiency restrictions are going into effect, thus increasing the demand for a reduction in rolling resistance in run flat tires.

One of the ways of reducing rolling resistance in a regular tire is to reduce the ratio TW/SW, where TW is the half width in the tire width direction between the pair of tread edges, and SW is half of the tire maximum width. By reducing TW to reduce the amount of rubber in the crown portion, the weight and rolling resistance can be lowered. From this perspective, the relationship TW/SW≦0.88 for an aspect ratio of 45 or less and the relationship TW/SW≦0.83 for an aspect ratio of 50 or higher has conventionally been considered preferable. Hence, as the aspect ratio is higher, a lower ratio TW/SW has been considered preferable.

In a run flat tire, however, reducing the ratio TW/SW increases the deformation of the shoulder portion of the tire when the tire is punctured, thereby worsening the run tire durability. Unfortunately, if the gauge of the run flat reinforcement rubber is thickened to compensate, the rolling resistance worsens.

Therefore, it would be helpful to provide a run flat tire in which the ride comfort during regular running, the durability during run flat running, and a reduction in rolling resistance are all compatible.

### Solution to Problem

A summary of this disclosure is as follows.

My run flat tire comprises:

a carcass toroidally extending between a pair of bead portions; and

side reinforcing rubber on an inside of the carcass in a tire width direction, the side reinforcing rubber having a crescent cross-sectional shape in the tire width direction; wherein

0.09≦TWH/TW≦0.19,

D/SH≦0.05, and

0.89≦TW/SW≦0.94,

where, in a reference state such that the run flat tire is mounted on an applicable rim and inflated to a prescribed internal pressure with no load applied, TW (mm) represents a half width in the tire width direction between a pair of tread edges, TWH (mm) represents a drop height of the tread edge in a tire radial direction, SW (mm) represents half of a tire maximum width, SH (mm) represents a cross-sectional height of the tire, and D (mm) represents a drop height of the tire at a position 0.6SW (mm) outward, in the tire width direction, from a tire equatorial plane.

As used herein, an “applicable rim” refers to a rim specified by the standards below in accordance with tire size, “prescribed internal pressure” refers to air pressure specified by the standards below in accordance with the maximum load capability, and the “maximum load capability” refers to the maximum mass that the tire is allowed to bear according to the standards below. The standards are determined by valid industrial standards for the region in which the tire is produced or used, such as the “Year Book” of “THE TIRE AND RIM ASSOCIATION, INC. (TRA)” in the United States of America, the “STANDARDS MANUAL” of “The European Tyre and Rim Technical Organisation (ETRTO)” in Europe, and the “JATMA YEAR BOOK” of the “Japan Automobile Tyre Manufacturers Association” in Japan.

The “drop height” refers to the tire radial distance, in the aforementioned reference state, between the tread surface at a predetermined position in the tire width direction and the tread surface position at the tire equatorial plane. Furthermore, the “tread edges” refer to the edges, in the tire width direction, of the entire outer circumferential surface of the tire (tread surface) that comes into contact with the road surface when the run flat tire is attached to an applicable rim, filled to a prescribed internal pressure, and rolled while being placed under a load corresponding to the maximum load capability. The “cross-sectional height of the tire” refers to the tire radial distance from the bead base to the outermost position in the tire radial direction in a cross-section of the tire in the tire width direction.

### Advantageous Effect

According to this disclosure, a run flat tire in which the ride comfort during regular running, the durability during run flat running, and a reduction in rolling resistance are all compatible can be provided.

### BRIEF DESCRIPTION OF THE DRAWINGS

In the accompanying drawings:

FIG. 1 is a cross-sectional diagram in the tire width direction of a run flat tire according to one of the disclosed embodiments.

### DETAILED DESCRIPTION

The following describes embodiments of this disclosure in detail with reference to the drawing.

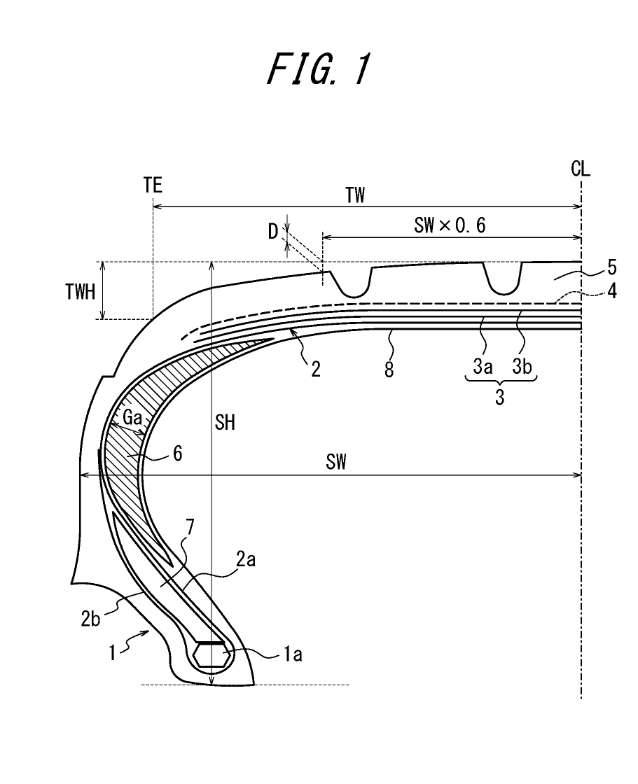

FIG. 1 is a cross-sectional diagram in the tire width direction of a run flat tire according to one of the disclosed embodiments. FIG. 1 only illustrates one half portion that is bordered by the tire equatorial plane CL. The other half portion has the same structure as the illustrated half portion and is therefore omitted. FIG. 1 illustrates the run flat tire in a standard state in which the run flat tire is mounted on an applicable rim and inflated to a prescribed internal pressure with no load applied.

As illustrated in FIG. 1, the run flat tire of this embodiment (hereinafter also simply referred to as a tire) is provided with a carcass 2 constituted by a carcass body portion 2a, toroidally extending between bead portions 1 in which a pair (only one of which is illustrated) of bead cores 1a are embedded, and a carcass folded-up portion 2b that continues from the carcass body portion 2a and turns up around the bead cores 1a. In the illustrated example, the end of the carcass folded-up portion 2b is positioned on the outer side in the tire radial direction with respect to the tire maximum width portion, but the end of the carcass folded-up portion 2b may, for example, extend to a point on the inner side in the tire width direction with respect to the tire width direction end of the belt layers 3a, 3b. The carcass 2 may, for example, be configured by at least one carcass ply constituted by organic fiber cords, steel cords, or the like.

In the illustrated example, the tire includes a belt 3, one belt reinforcement layer 4, and a tread 5 in this order on the outer side of the carcass 2 in the tire radial direction. The belt 3 is formed by two belt layers 3a and 3b. The two belt layers 3a and 3b in the illustrated example are formed by belt cords, such as organic fiber cords or steel cords, that extend at an inclination with respect to the tire circumferential direction. The belt cords of the two belt layers 3a and 3b extend in directions that intersect each other. In the illustrated example, the belt reinforcement layer 4 is formed by organic fiber cords or steel cords that extend substantially in the tire circumferential direction. The number of layers, the material, the location, and other aspects of the configuration of the belt 3 and the belt reinforcement layer 4 may be modified as necessary. For example, the belt reinforcement layer 4 may have two layers only at the outer side edges, in the tire width direction, of the belt layers 3a and 3b.

As illustrated in FIG. 1, this tire also includes, in the side portion thereof, side reinforcing rubber 6 on the inside of the carcass 2 in the tire width direction. The side reinforcing rubber 6 has a crescent cross-sectional shape in the tire width direction. In other words, in a tire width direction cross-section, the thickness of the side reinforcing rubber 6 gradually decreases in the tire width direction from near the central position of the side reinforcing rubber 6 in the tire radial direction towards the inside and the outside in the tire radial direction, and the side reinforcing rubber 6 has a shape projecting outward in the tire width direction. As illustrated in FIG. 1, the side reinforcing rubber 6 has a maximum thickness Ga near the central position in the tire radial direction. In a cross-section in the tire width direction, the maximum thickness Ga of the side reinforcing rubber 6 is the maximum distance between a point on the curved inner surface of the side reinforcing rubber 6 in the tire width direction and a point where a normal line from the point on the inner surface intersects the outer surface of the side reinforcing rubber 6 in the tire width direction. By providing such side reinforcing rubber 6, even when the internal pressure of the tire is reduced due to a puncture or the like, the side reinforcing rubber 6 contributes to supporting the vehicle body weight, allowing the vehicle to be driven safely for a certain distance.

As illustrated in FIG. 1, a bead filler 7 is disposed on the outside, in the tire radial direction, of the bead core 1a. In this example, the bead filler 7 has a tapered shape in which the width, in the tire width direction, of the tip on the outside in the tire radial direction narrows. As illustrated in FIG. 1, an inner liner 8 that is highly impermeable to air is disposed on the inner surface of the tire.

In the aforementioned reference state, TW (mm) represents the half width in the tire width direction between the pair of tread edges TE, TWH (mm) represents the drop height of the tread edge TE in the tire radial direction, SW (mm) represents half of the tire maximum width, SH (mm) represents the cross-sectional height of the tire, and D (mm) represents the drop height of the tire at a position 0.6SW (mm) outward, in the tire width direction, from the tire equatorial plane CL.

At this time, in the run flat tire of this embodiment, the following relational expressions (1) to (3) are satisfied simultaneously.

0.09≦TWH/TW≦0.19 (1)

D/SH≦0.05 (2)

0.89≦TW/SW≦0.94 (3)

The following describes the effects of the run flat tire according to this embodiment.

First, relational expression (1) is explained.

In this embodiment, the ratio TWH/TW is set to 0.09 or higher, thereby expanding the area in which the tread 5 can deform. Accordingly, from a low load to a regular load (approximately 70% of the maximum load capability), the load due to load fluctuation can be received by the change in the tread 5, deformation of the tire side portion can be suppressed, and the vertical spring constant of the tire can be reduced. The ride comfort can thus be improved during regular running. If the ratio TWH/TW exceeds 0.19, however, deformation during run flat running cannot be suppressed, and the durability during run flat running ends up degrading. As described above, by satisfying relational expression (1), the ride comfort during regular running can be made compatible with durability during run flat running.

Next, relational expression (2) is explained.

In this embodiment, since the ratio D/SH is 0.05 or lower, a large footprint area can be guaranteed in the central region, in the tire width direction, of the tread 5. Accordingly, distortion of the side reinforcing rubber 6 during run flat running can be kept small, and durability during run flat running can be improved. In this way, by satisfying relational expression (2), durability during run flat running can be improved.

On the other hand, in order to suppress deformation of the shoulder portion during a regular load (approximately 70% to 80% of the maximum load) and to suppress a worsening of rolling resistance, the relational expression of ratio D/SH≧0.02 is preferably satisfied.

Next, relational expression (3) is explained.

In this embodiment, since the ratio TW/SW is set to 0.94 or lower, the amount of tread rubber can be reduced, thus reducing the rolling resistance.

On the other hand, since the ratio TW/SW is set to 0.89 or higher in this embodiment, distortion of the tread rubber can be reduced, which reduces the rolling resistance. In this way, by satisfying relational expression (3), the rolling resistance can be reduced.

As described above, by simultaneously satisfying relational expressions (1) to (3), the ride comfort during regular running, the durability during run flat running, and a reduction in rolling resistance can all be made compatible.

In the run flat tire of this disclosure, relational expression (4) below is preferably satisfied.

0.89≦TW/SW≦0.92 (4)

This range is preferable because, for reasons similar to those described above, setting the ratio TW/SW to be 0.92 or lower can further reduce the amount of tread rubber, which further reduces the rolling resistance. On the other hand, setting the ratio TW/SW to be 0.89 or higher further reduces the distortion in the tread rubber, thus further reducing the rolling resistance.

Furthermore, in the run flat tire of this disclosure, relational expression (5) below is preferably satisfied.

0.12≦TWH/TW≦0.19 (5)

This range is preferable because, for reasons similar to those described above, the ride comfort during regular running can be further improved by setting the ratio TWH/TW to be 0.12 or higher.

In this disclosure, the radius of curvature R of the tire outer surface at the tread edge TE is preferably 35 mm or less and more preferably 25 mm or less.

The reason is that collapsing of the side portion during run flat running can be suppressed, and the durability during run flat running can be improved.

Furthermore, in this disclosure, the maximum thickness Ga of the side reinforcing rubber 6 is preferably from 6 mm to 8 mm when SH 110 mm. The reason is that the run flat durability can be guaranteed by setting the maximum thickness Ga to be 6 mm or higher, whereas worsening of the rolling resistance can be suppressed with a setting of 8 mm or lower. The maximum thickness Ga of the side reinforcing rubber 6 is preferably from 8 mm to 10 mm when 110 mm≦SH≦130 mm. The reason is that the run flat durability can be guaranteed by setting the maximum thickness Ga to be 8 mm or higher, whereas worsening of the rolling resistance can be suppressed with a setting of 10 mm or lower.

### Examples

In order to confirm the effects of my tire, test tires for Examples 1-20 and Comparative Examples 1-11 were prepared, and the following tests were performed to evaluate tire performance.

<Vertical Spring Constant>

After being mounted on an approved rim prescribed by JATMA, each tire was inflated to a tire internal pressure of 230 kPa, a load that was 70% of a load corresponding to the maximum load capability was applied in the tire radial direction, and deflection of the tire in the tire radial direction was measured. As the numerical value for the indices in Tables 1 to 6 is smaller, the ride comfort is better.

### <Run Flat Durability>

For each tire, the running distance was measured in a run flat durability drum according to ISO conditions. As the numerical value for the indices in Tables 1 to 6 is larger, the run flat durability is better.

### <Rolling Resistance>

For each tire, the rolling resistance according to ISO conditions was measured. As the numerical value for the indices in Tables 1 to 6 is smaller, the rolling resistance is further reduced.

In Tables 1 to 6, the radius of curvature R (mm) refers to the radius of curvature of the tire outer surface at the tread edge TE.

First, various aspects of tire performance were evaluated while changing the ratio TWH/TW for the tires according to Examples 1 to 4 and Comparative Examples 1 and 2, which had a tire size of 225/45R17. The specifications of each tire and the evaluation results are shown in Table 1. Similarly, various aspects of tire performance were evaluated while changing the ratio TWH/TW for the tires according to Examples 5 to 8 and Comparative Examples 3 and 4, which had a tire size of 255/35R19. The specifications of each tire and the evaluation results are shown in Table 2. Table 1 lists relative values with the evaluation results for Comparative Example 1 each being 100, and Table 2 lists relative values with the evaluation results for Comparative Example 3 each being 100.

TABLE 1

| | Comparative | | | | | Comparative |
|---|---|---|---|---|---|---|
| | Example 1 | Example 1 | Example 2 | Example 3 | Example 4 | Example 2 |
| TW/SW | 0.9 | 0.9 | 0.9 | 0.9 | 0.9 | 0.9 |
| TWH/TW | 0.07 | 0.09 | 0.12 | 0.15 | 0.19 | 0.21 |
| D/SH | 0.03 | 0.03 | 0.03 | 0.03 | 0.03 | 0.03 |
| Radius of | 25 | 25 | 25 | 25 | 25 | 25 |
| curvature R (mm) | | | | | | |
| Ga (mm) | 7.0 | 7.0 | 7.4 | 7.7 | 8.1 | 8.3 |
| Vertical spring | 100 | 98 | 96 | 93 | 89 | 87 |
| constant | | | | | | |
| Run flat durability | 100 | 100 | 100 | 100 | 100 | 100 |
| Rolling resistance | 100 | 99 | 98 | 98 | 100 | 102 |
| coefficient | | | | | | |

TABLE 2

| | Comparative | | | | | Comparative |
|---|---|---|---|---|---|---|
| | Example 3 | Example 5 | Example 6 | Example 7 | Example 8 | Example 4 |
| TW/SW | 0.9 | 0.9 | 0.9 | 0.9 | 0.9 | 0.9 |
| TWH/TW | 0.07 | 0.09 | 0.12 | 0.15 | 0.19 | 0.21 |
| D/SH | 0.03 | 0.03 | 0.03 | 0.03 | 0.03 | 0.03 |
| Radius of | 25 | 25 | 25 | 25 | 25 | 25 |
| curvature R (mm) | | | | | | |
| Ga (mm) | 6.5 | 6.7 | 7.0 | 7.4 | 7.8 | 8.0 |
| Vertical spring | 100 | 98 | 95 | 92 | 88 | 86 |
| constant | | | | | | |
| Run flat durability | 100 | 100 | 100 | 100 | 100 | 100 |
| Rolling resistance | 100 | 99 | 98 | 99 | 100 | 103 |
| coefficient | | | | | | |

Tables 1 and 2 show that in the range of 0.09≦TWH/TW≦0.19, ride comfort during regular running and durability during run flat running are made compatible. In particular, in the case of the ratio TWH/TW being 0.12 or higher, the ride comfort during regular running is clearly excellent.

Next, various aspects of tire performance were evaluated while changing the ratio D/SH for the tires according to Examples 9 and 10 and Comparative Example 5, which had a tire size of 225/45R17. The specifications of each tire and the evaluation results are shown in Table 3. Similarly, various aspects of tire performance were evaluated while changing the ratio D/SH for the tires according to Examples 11 and 12 and Comparative Example 6, which had a tire size of 255/35R19. The specifications of each tire and the evaluation results are shown in Table 4. Table 3 lists relative values with the evaluation results for Comparative Example 5 each being 100, and Table 4 lists relative values with the evaluation results for Comparative Example 6 each being 100.

TABLE 3

| | | | Comparative |
|---|---|---|---|
| | Example 9 | Example 10 | Example 6 |
| TW/SW | 0.9 | 0.9 | 0.9 |
| TWH/TW | 0.15 | 0.15 | 0.15 |
| D/SH | 0.03 | 0.05 | 0.06 |
| Radius of curvature | 25 | 25 | 25 |
| R (mm) | | | |
| Ga (mm) | 7.0 | 7.0 | 7.0 |
| Vertical spring | 101 | 100 | 100 |
| constant | | | |
| Run flat durability | 105 | 102 | 100 |
| Rolling resistance | 100 | 99 | 100 |
| coefficient | | | |

TABLE 4

| | | | Comparative |
|---|---|---|---|
| | Example 11 | Example 12 | Example 7 |
| TW/SW | 0.9 | 0.9 | 0.9 |
| TWH/TW | 0.15 | 0.15 | 0.15 |
| D/SH | 0.03 | 0.05 | 0.06 |
| Radius of curvature | 25 | 25 | 25 |
| R (mm) | | | |
| Ga (mm) | 6.5 | 6.5 | 6.5 |
| Vertical spring | 101 | 100 | 100 |
| constant | | | |
| Run flat durability | 107 | 103 | 100 |
| Rolling resistance | 100 | 100 | 100 |
| coefficient | | | |

Tables 3 and 4 show that when the ratio D/SH≦0.05 is satisfied, durability during run flat running is improved.

Next, various aspects of tire performance were evaluated while changing the ratio TW/SW for the tires according to Examples 13 to 16 and Comparative Examples 8 and 9, which had a tire size of 225/45R17. The specifications of each tire and the evaluation results are shown in Table 5. Similarly, various aspects of tire performance were evaluated while changing the ratio TW/SW for the tires according to Examples 17 to 20 and Comparative Examples 10 and 11, which had a tire size of 255/35R19. The specifications of each tire and the evaluation results are shown in Table 6. Table 5 lists relative values with the evaluation results for Comparative Example 8 each being 100, and Table 6 lists relative values with the evaluation results for Comparative Example 10 each being 100.

TABLE 5

| | Comparative | | | | | Comparative |
|---|---|---|---|---|---|---|
| | Example 8 | Example 13 | Example 14 | Example 15 | Example 16 | Example 9 |
| TW/SW | 0.84 | 0.89 | 0.9 | 0.92 | 0.94 | 0.96 |
| TWH/TW | 0.15 | 0.15 | 0.15 | 0.15 | 0.15 | 0.15 |
| D/SH | 0.03 | 0.03 | 0.03 | 0.03 | 0.03 | 0.03 |
| Radius of | 25 | 25 | 25 | 25 | 25 | 25 |
| curvature R (mm) | | | | | | |
| Ga (mm) | 7.5 | 6.9 | 6.8 | 6.6 | 6.4 | 6.1 |
| Vertical spring | 100 | 100 | 100 | 99 | 99 | 99 |
| constant | | | | | | |
| Run flat durability | 100 | 100 | 100 | 100 | 100 | 100 |
| Rolling resistance | 100 | 98 | 97 | 98 | 99 | 102 |
| coefficient | | | | | | |

TABLE 6

| | Comparative | | | | | Comparative |
|---|---|---|---|---|---|---|
| | Example 10 | Example 17 | Example 18 | Example 19 | Example 20 | Example 11 |
| TW/SW | 0.84 | 0.89 | 0.9 | 0.92 | 0.94 | 0.96 |
| TWH/TW | 0.15 | 0.15 | 0.15 | 0.15 | 0.15 | 0.15 |
| D/SH | 0.03 | 0.03 | 0.03 | 0.03 | 0.03 | 0.03 |
| Radius of | 25 | 25 | 25 | 25 | 25 | 25 |
| curvature R (mm) | | | | | | |
| Ga (mm) | 7.0 | 6.4 | 6.3 | 6.0 | 5.8 | 5.5 |
| Vertical spring | 100 | 100 | 100 | 100 | 100 | 100 |
| constant | | | | | | |
| Run flat durability | 100 | 100 | 100 | 100 | 100 | 100 |
| Rolling resistance | 100 | 98 | 97 | 98 | 99 | 102 |
| coefficient | | | | | | |

Tables 5 and 6 show that the rolling resistance is good in a range satisfying the relationship 0.89≦TW/SW≦0.94. In particular, the rolling resistance is even better in the range 0.89≦TW/SW≦0.92.

As described above, by simultaneously satisfying relational expressions (1) to (3), the ride comfort during regular running, the durability during run flat running, and a reduction in rolling resistance can all be made compatible.

Furthermore, by satisfying relational expression (4), the ride comfort during regular running in particular is good, and by satisfying relational expression (5), the rolling resistance in particular can be reduced.

### REFERENCE SIGNS LIST

1 Bead portion
1a Bead core
2 Carcass
2a Carcass body portion
2b Carcass folded-up portion
3a, 3b Belt layer
3 Belt
4 Belt reinforcement layer
5 Tread
6 Side reinforcing rubber
7 Bead filler
8 Inner liner
CL Tire equatorial plane
TE Tread edge

1. A run flat tire comprising:
a carcass toroidally extending between a pair of bead portions; and
side reinforcing rubber on an inside of the carcass in a tire width direction, the side reinforcing rubber having a crescent cross-sectional shape in the tire width direction; wherein
0.09≦TWH/TW≦0.19,
D/SH≦0.05, and
0.89≦TW/SW≦0.94,
where, in a reference state such that the run flat tire is mounted on an applicable rim and inflated to a prescribed internal pressure with no load applied, TW (mm) represents a half width in the tire width direction between a pair of tread edges, TWH (mm) represents a drop height of the tread edge in a tire radial direction, SW (mm) represents half of a tire maximum width, SH (mm) represents a cross-sectional height of the tire, and D (mm) represents a drop height of the tire at a position 0.6SW (mm) outward, in the tire width direction, from a tire equatorial plane.

2. The run flat tire of claim 1, wherein 0.89≦TW/SW≦0.92.

3. The run flat tire of claim 1, wherein 0.12≦TWH/TW≦0.19.

4. The run flat tire of claim 2, wherein 0.12≦TWH/TW≦0.19.
